(19) United States
(12) Patent Application Publication
(10) Pub. No.: US 2006/0265423 A1
(43) Pub. Date: Nov. 23, 2006

(54) Alteration Of Photographs Generated From Mobile Devices

(76) Inventor: Robert Schinker, Plymouth, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/419,397

(22) Filed: May 19, 2006

Related U.S. Application Data
(60) Provisional application No. 60/682,732, filed on May 19, 2005.

(51) Int. Cl. G06F 17/00; G06F 7/00

(52) U.S. Cl. 707/104.1

(57) ABSTRACT

A method creates a requested multimedia file (22) from an initial file (34) having at least one of an image (28) and text (30) from a template (44). The template (44) is stored on a server (24), which has at least one template (44), and each template (44) has a unique designation code (66). The method includes the steps of receiving the initial file (34) at the server (24), receiving the unique designation code (66) of the template (44) at the server (24) to define a selected template (60), and automatically combining the initial file (34) with the selected template (60) to produce the requested multimedia file (22) upon receiving the initial file (34) and the unique designation code (66) at the server (24).

### CROSS REFERENCE TO RELATED APPLICATION

This application claims the benefit of application Ser. No. 60/682,732 filed May 19, 2005.

### BACKGROUND OF THE INVENTION

1. Field of the Invention

The subject invention relates to a method of creating a requested multimedia file from an initial file and at least one template and each template being associated with a unique designation code.

2. Description of the Prior Art

Multimedia files transmitted using cellular phones is a growing industry. Using a Multimedia Messaging Service (MMS), various kinds of multimedia content, including images, audio, video, and text, may be transmitted wirelessly. The multimedia content may be transmitted between cellular phones or alternatively, between a cellular phone and a server. The cellular phone may be connected to the server via the internet or through another device connected to the internet. Other devices may include a computer or a printer with internet capabilities. In addition, software programs are available to alter multimedia content with the cellular phone. Using one of the software programs, content may be downloaded to the cellular phone from a server. Often, to access the content stored on the server, the user must set up an account.

An example of such a system is found in PCT Application WO 2004/052035 (the '035 publication). The '035 publication discloses a method of creating a requested multimedia file from an initial file with a cellular phone. After objects are photographed and stored in the initial file, the initial file is altered on the cellular phone using software program stored on the cellular phone. The software program prompts the user to alter the initial file to create the requested multimedia file. Such prompts include changing the size of the initial file or selecting a template to combine with the initial file.

Creating the requested multimedia file with the software program is time consuming since the user needs to configure the initial file before it may be combined with the template. If the software program is not preloaded on the phone, the user needs to purchase the software program separately and upload the software program to the phone. The software program may be incompatible with cellular phones made by different manufacturers or utilizing different operating systems, requiring the user to have a higher level of sophistication to purchase, download, or use the software program to create the requested multimedia file. Although the method employed by the prior art may be enjoyed by various users of cellular phones, there remains an opportunity to improve upon the prior art by requiring less user interaction to create the requested multimedia file.

### SUMMARY OF THE INVENTION AND ADVANTAGES

The invention provides for a method of creating a requested multimedia file from an initial file having at least one of an image and text. The method utilizes a server having at least one template accessible therefrom, and each template is associated with a unique designation code. The method comprises the steps of receiving the initial file at the server, receiving the unique designation code associated with a template at the server to define a selected template, and automatically combining the initial file with the selected template to produce the requested multimedia file upon receiving the initial file and the unique designation code at the server.

Accordingly, the subject method automatically reduces user interaction when creating the requested multimedia file. Specifically, the subject method does not require the user to be as sophisticated with respect to the capture device, such as a cellular phone, or with software programs that are used to create the requested multimedia file. Likewise, creating the requested multimedia file may be less time consuming since the user is not required to configure the initial file before creating the requested multimedia file. Furthermore, the subject method works without requiring the capture device to employ extraneous software programs, reducing compatibility issues between an operating system of the capture device and the software program.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is an illustration of a system for creating a requested multimedia file in accordance with the subject invention;

FIG. 2 is an illustration of one embodiment of a template that may be used in the system shown in FIG. 1 in accordance with the subject invention;

FIG. 3 is an illustration of another embodiment of a template that may be used in the system shown in FIG. 1 in accordance with the subject invention;

FIG. 4 is an illustration of yet another embodiment of a template that may be used in the system shown in FIG. 1 in accordance with the subject invention;

FIG. 5 is a flowchart of a first embodiment of a method for creating the requested multimedia file in accordance with the subject invention;

FIG. 6 is a flowchart of a second embodiment of the method for creating the requested multimedia file in accordance with the subject invention;

FIG. 7 is an illustration of a capture device and the template used in the system of FIG. 1 in accordance with the subject invention;

FIG. 8 is an illustration of yet another template used in the system shown in FIG. 1 in accordance with the subject invention; and

FIG. 9 is an illustration of the capture device and the template used in the system of FIG. 1 in accordance with the subject invention.

### DETAILED DESCRIPTION OF THE INVENTION

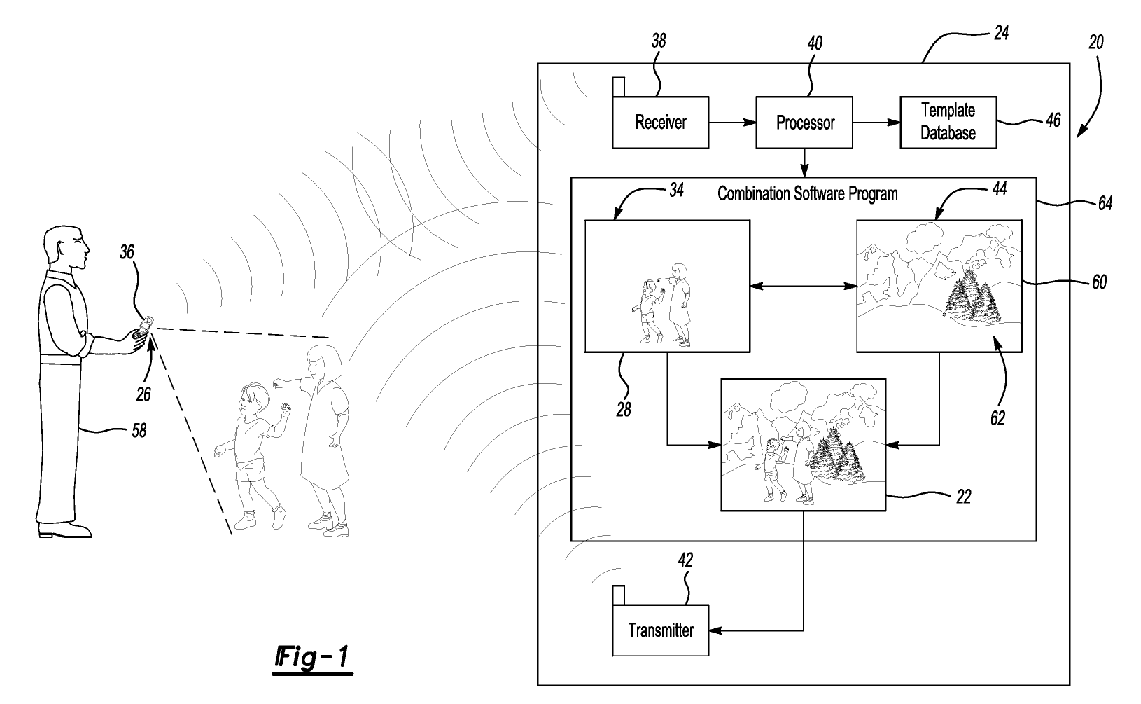

Referring to the Figures, wherein like numerals indicate corresponding parts throughout the several views, a system 20 for creating a requested multimedia file 22 is shown generally in FIG. 1. The system 20 includes a server 24 in communication with a capture device 26. The capture device 26 is any device that is able to capture an image 28 or text 30. Some examples of the capture device may include a camera to capture the image 28 or a keyboard or keypad 32 to capture the text 30. A cellular phone is a device that combines a camera and a keypad to capture the image 28 and the text 30, although other capture devices 26 are within the scope of the subject invention. The capture device 26 may be equipped with preloaded software to capture the image 28 and the text 30. The preloaded software may also allow the capture device 28 to create an initial file 34 and to transmit the initial file 34. It should be understood that the initial file 34 may include the image 28, the text 30, or both. The capture device 26 employs a communication protocol with a messaging service, such as a Multimedia Messaging Service (MMS) for transmitting the image 28 or a Short Messaging Service (SMS) for transmitting the text 30.

The server 24 may communicate over either a wired or wireless connection with the capture device 26. The wired connection may include any physical connection between the capture device 26 and the server 24. For example, the wired connection may be through a universal serial bus (USB), PS/2, or IEEE 1394b (FireWire®), among others. For wireless communication, the server 24 may include a receiver 38 in communication with a processor 40 and a transmitter 42. Alternatively, the receiver 38 and the transmitter 42 may be the same device, such as a transceiver. Both the receiver 38 and the transmitter 42 may use any wireless communication protocol known in the art, for example, wireless application protocol (WAP). Also, the receiver 38 and the transmitter 42 may transmit signals using any known frequency band, including frequency bands associated with radio frequency (RF), Bluetooth®, IR, code division multiple access (CDMA), time division multiple access (TDMA), or global system for mobile communications (GSM), among others.

The server 24 stores and accesses at least one template 44 in a template database 46, and in one embodiment, the server 24 may store a plurality of templates 44. The template database 46 is in communication with the processor 40. In one embodiment, the image 28 may be captured in front of a removable background, such as a green screen, and the image 28 without the background is placed over the template 44. For example, a photo booth may be the capture device 26 used to capture the image 28 in front of the removable background. The photo booth may correspond with a promotion, such as to promote a movie. In this embodiment, the capture device 26 captures the image 28 and removes the removable background. The image is then combined with the template 44 to make it appear as though a subject of the image 28 is in a scene represented by the template 44.

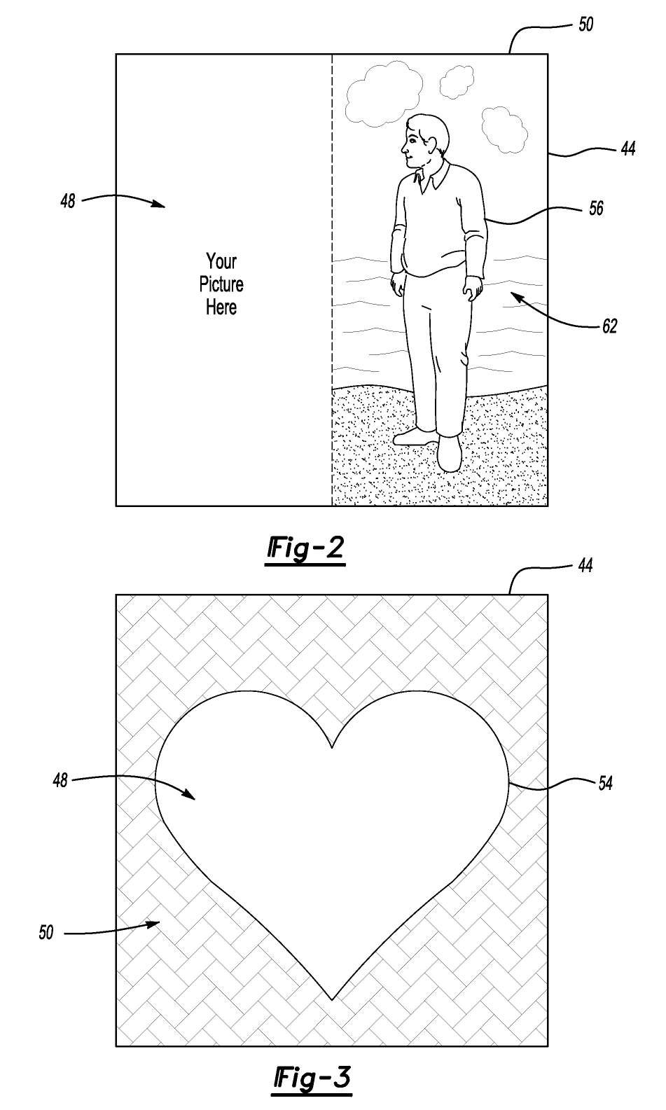

Alternatively, the template 44 may be placed over the image 28. Various templates 44 are shown in FIGS. 2-4. Each template 44 in the template database 46 may include at least one of a transparent section 48, an opaque section 50, and a text overlay portion 52. It is to be appreciated that any one of the transparent section 48, the opaque section 50, and the text overlay portion 52 may not be included on the templates 44. Referring now to FIG. 2, in the templates 44, the transparent section 48 and the opaque section 50 may be located anywhere within the template 44. In one embodiment, the opaque section 50 covers a portion of the initial file 34, and the initial file 34 shows through the transparent section 48. This way, the opaque section 50 appears to be part of the image 28 in the requested multimedia file 22. In another embodiment, the transparent section 48 has a defined area adjacent to the opaque section 50, and the initial file 34 is resized to fit entirely within the transparent section 48. These embodiments may also be combined such that the initial file 34 is resized to fit into the transparent section 48, and the opaque section 50 may extend over the initial file 34 to blend the initial file 34 into the template 44.

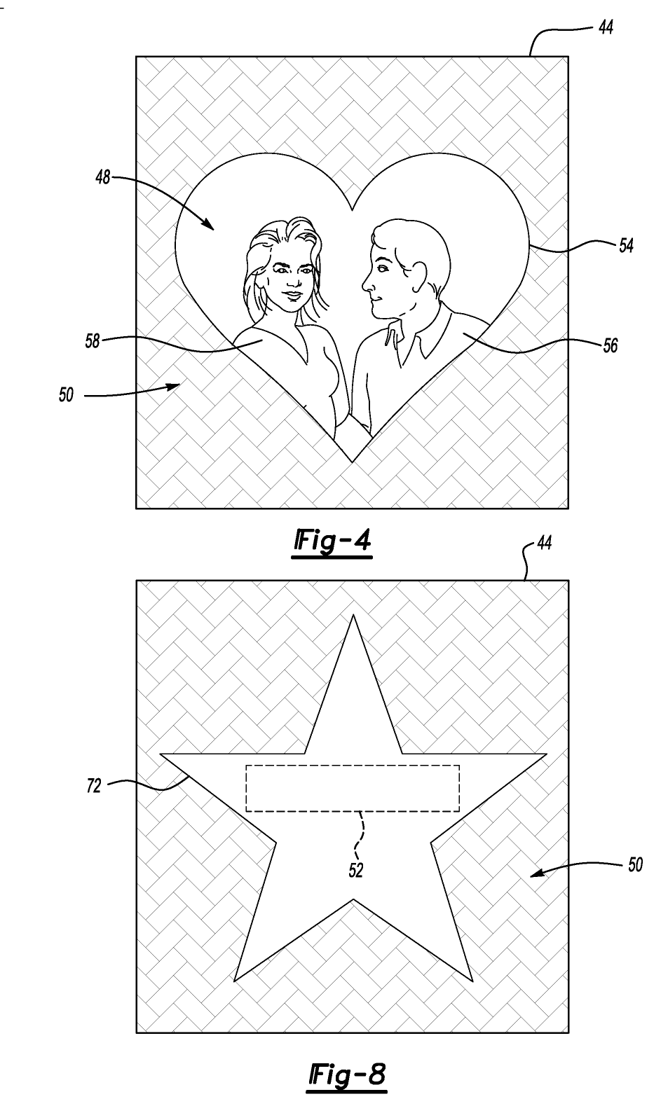

Referring now to FIG. 3, in another embodiment, the opaque section 50 may define a border 54, such as a heart shaped border, although borders 54 of other shapes are within the scope of the subject invention. Additionally, as shown in FIG. 4, the border 54 may include the picture of a celebrity 56, and the user 58 in the initial file 34 will appear to be in the heart with the celebrity 56 in the requested multimedia file 22. The opaque section 50 of the selected template 60 may include but is not limited to, pictures of celebrities 56, a scene from a movie, pictures of movie characters, pictures of cartoon characters, a scene from a television show, pictures of television show characters, or a scene from a geographic location 62.

Referring back to FIG. 1, the server 24 further employs a combination software program 64. The combination software program 64 is used to combine the initial file 34 with the template 44 to create the requested multimedia file 22. The combination software program 64 may operate within the server 24 as shown in FIG. 1, or alternatively, the combination software program 64 may operate on an external computer in communication with the server 24. The combination software program 64 may communicate with the transmitter 42 to send the requested multimedia file 22 to the capture device 26 using routing information transmitted with the initial file 34 and the unique designation code 66. The routing information may instruct the server 24 to transmit the requested multimedia file 22 back to the capture device 26 that originally transmitted the initial file 34, or alternatively, the routing information may instruct the server 24 to transmit the requested multimedia file 22 to another capture device 26. It is to be appreciated that the requested multimedia file 22 may be stored on the server 24, or alternatively uploaded to a second server connected to the internet, to allow the user 58 to download the requested multimedia file 22 to the capture device 26 or any other electronic device, such as a computer.

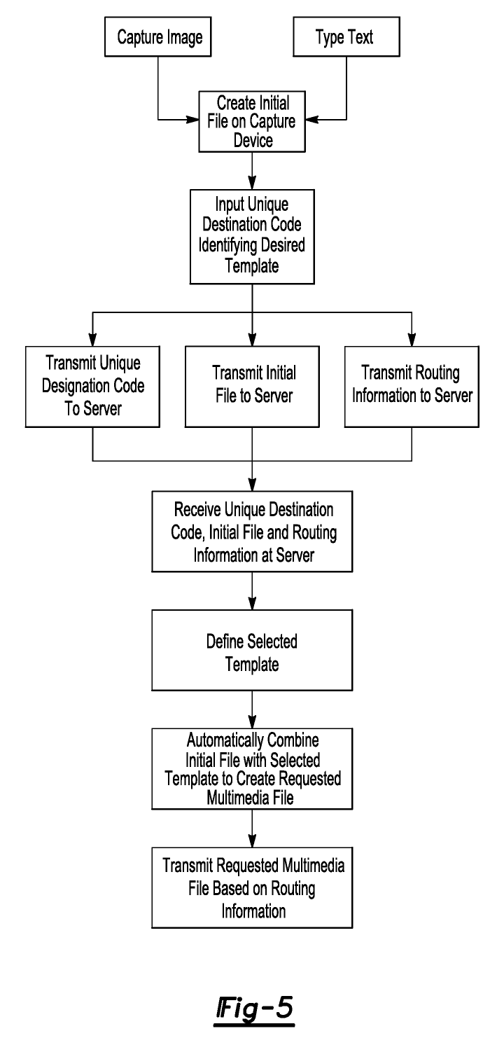

Referring now to FIG. 5, one method of performing the subject invention is illustrated in a flow chart. In operation, a user 58 creates the initial file 34 by capturing the image 28 or typing text 30 using the capture device 26. Next, the user 58 decides which template 44 to combine with the initial image 28, for example, the user 58 may encounter a promotional advertisement providing different templates 44 for combining with the initial file 34. The advertisement may include instructions about selecting the template 44 and capturing the image 28 or text 30 in a way that a subject in the initial file 34 can be seen through the transparent section 48 of the template 44. For instance, the advertisement may instruct the user 58 to place the subject is on the left side of the initial file 34. In order to distinguish between templates 44, a unique designation code 66 is associated with each of the templates 44. The unique designation code 66 is linked to one of the templates 44 such that when the unique designation code 66 is received at the server 24, the unique designation code 66 defines a selected template 60. The user 58 transmits the initial file 34 and the unique designation code 66 to the server 24 to automatically combine the initial file 34 with the selected template 60 without requiring sophisticated interaction between the user 58 and software operating on the capture device 26 to create the requested multimedia file 22

The user 58 may transmit the initial file 34 and the unique designation code 66 to the server 24 using various means known in the art. For example, the server 24 may be designated by a short code 68, which is known in the art to be similar to a telephone number. In one embodiment, the short code 68 may be entered into the capture device 26 just as a telephone number would be entered into the capture device 26. In another embodiment, prior to transmitting the initial file 34, the unique designation code 66 may be typed as a text message 70 which may attached to the initial file 34 to be transmitted simultaneously with the initial file 34.

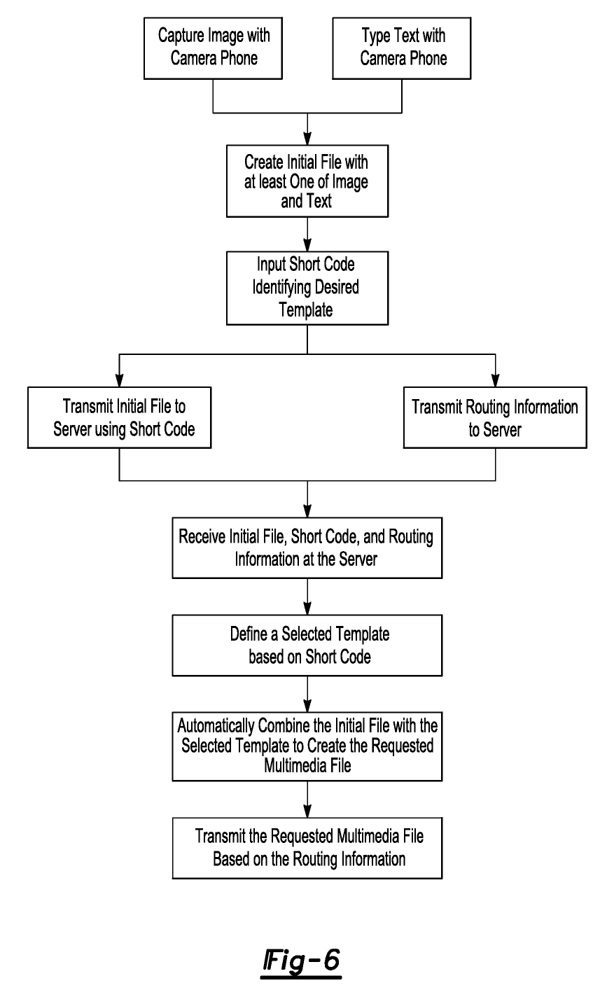

Referring to FIG. 6, another method of performing the subject invention is illustrated in a flow chart. In this embodiment, the short code 68 that designates the server 24 may also be the unique designation code 66 that selects the selected template 60. In other words, transmitting the initial file 34 using the short code 68 transmits the initial file 34 to the server 24 associated with the short code 68 while also indicating to the server 24 which template 44 stored on the server 24 is the selected template 60. This may be useful if the server 24 only stores one template 44, or if the server 24 stores multiple templates 44 and has multiple short codes 68 mapped to the server 24.

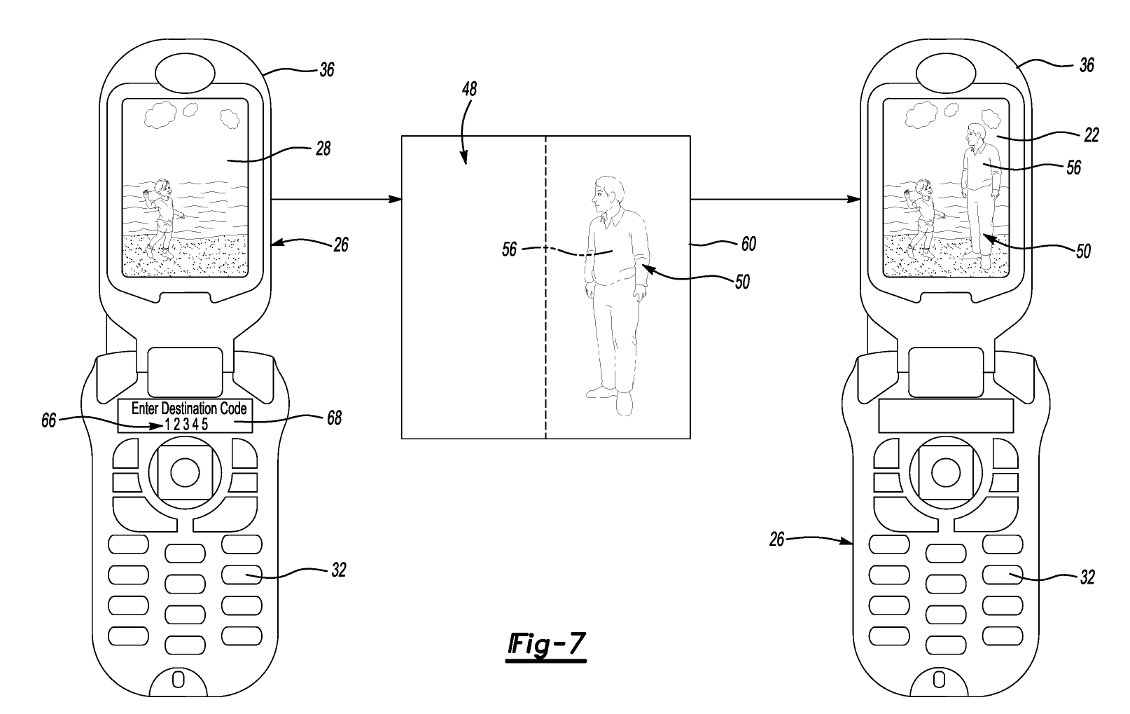

FIG. 7 is an illustrative example of the image 28 captured by the capture device 26 to create the initial file 34. By way of example, the image 28 shows the user 58 in a geographic location 62. The selected template 60 includes the transparent section 48 and the opaque section 50. The opaque section 50 is represented in the selected template 60 as the celebrity 56. Since the opaque section 50 of the template is on the right side of the selected template 60, the user 58 is instructed, for example in the advertisement, to capture the subject of the image on the left side of the image 28 so the subject of the image will not be covered by the opaque section 50. The image 28 is then combined with the selected template 60 to create the requested multimedia file 22. In order to combine the image 28 with the selected template 60, the image 28 may be resized to match a dimension of the selected template 60. Then, the selected template 60 may be placed over the image 28 to combine the requested multimedia file 22. Once combined, the requested multimedia file 22 is transmitted to the capture device 26. On the capture device 26, the requested multimedia file appears to show the subject of the image and the celebrity 56 together at the geographic location 62. It should be appreciated that the templates 44 shown in FIGS. 2-4 may be used similarly.

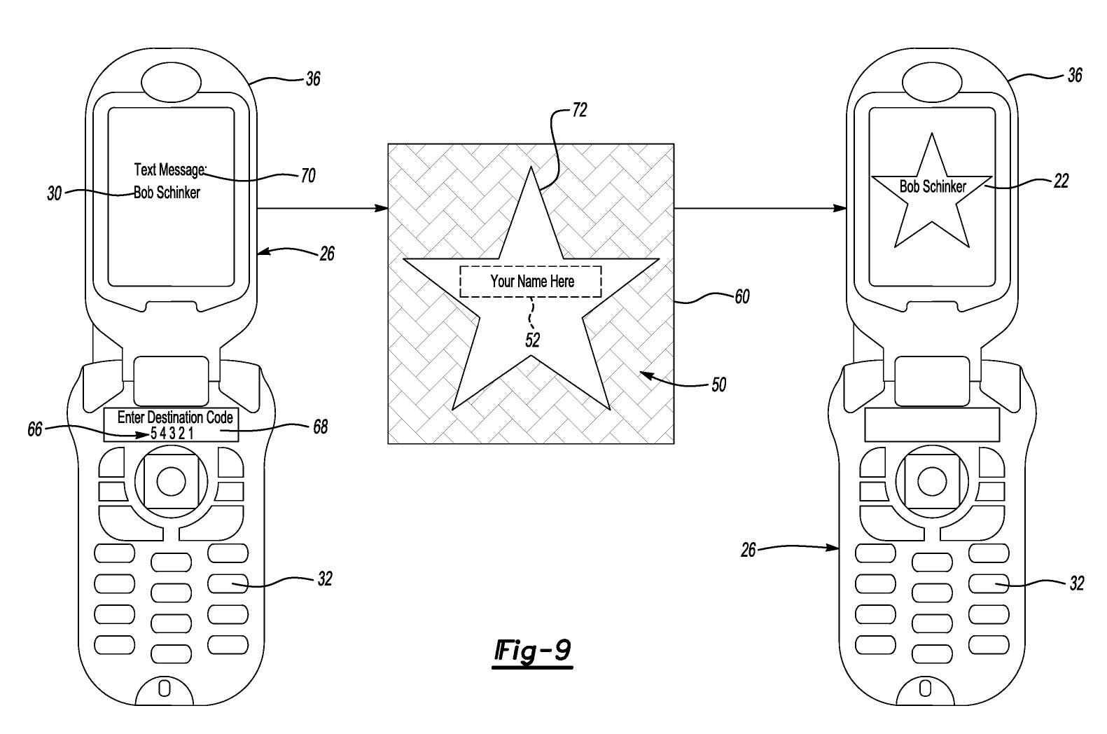

Alternatively, as shown in FIGS. 8-9, the initial file 34 may include text 30 instead of the image 28. In this case, the text 30 is combined with the selected template 60 at the text overlay portion 52 to create the requested multimedia file 22. Therefore, the text 30 in the initial file 34 appears to be written on the text overlay portion 52 of the selected template 60. For example, the selected template 60 may include a star 72 as commonly found on the “Hollywood Walk of Fame®”. The user 58 may type his name or any other text 30 into the initial file 34, and when combined with the selected template 60, the text 30 will appear to be on the star 72 in the requested multimedia file 22.

FIG. 9 is an illustrative example of the text 30 typed into the capture device 26 to create the initial file 34. The user 58 types the text 30 into the capture device 26 to create the initial file 34. The user 58 may be instructed to limit the text 30 to a maximum number of characters before sending the initial file 34 to the server 24 to be combined with the selected template 60. When combined with the selected template 60, the text 30 may be placed anywhere onto the selected template, for instance, over the text overlay portion 52, to create the requested multimedia file 22. Once combined, the requested multimedia file 22 is transmitted to the capture device 26. On the capture device 26, the requested multimedia file 22 appears to show the text 30 in the selected template 60, and in this example, the “Hollywood Walk of Fame®”.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of creating a requested multimedia file from an initial file having at least one of an image and text utilizing a server having at least one template accessible therefrom with each template having a unique designation code, said method comprising the steps of:
receiving the initial file at the server;
receiving the unique designation code of a template at the server to define a selected template; and
characterized by automatically combining the initial file with the selected template to produce the requested multimedia file upon receiving the initial file and the unique designation code at the server.

2. A method as set forth in claim 1 wherein said step of automatically combining the initial file with the selected template is further defined as automatically combining the image of the initial file with the selected template to produce the requested multimedia file.

3. A method as set forth in claim 1 wherein said step of automatically combining the initial file with the selected template is further defined as automatically combining text from the initial file with the selected template to produce the requested multimedia file.

4. A method as set forth in claim 1 wherein said step of receiving the designation code is further defined as receiving the designation code simultaneously with said step of receiving the initial file.

5. A method as set forth in claim 1 further including a step of receiving routing information.

6. A method as set forth in claim 5 wherein said step of receiving the routing information is further defined as receiving the routing information simultaneously with the designation code and the initial file.

7. A method as set forth in claim 5 further including a step of transmitting the requested multimedia file from the server based on the routing information.

8. A method as set forth in claim 7 wherein said step of transmitting the requested multimedia file is further defined as wirelessly transmitting the requested multimedia file from the server based on the routing information.

9. A method as set forth in claim 1 wherein said method further utilizes a capture device, said method further including a step of capturing the image of the initial file with the capture device.

10. A method as set forth in claim 1 wherein said method further utilizes a capture device, said method further including a step of typing the text into the initial file with the capture device.

11. A method as set forth in claim 1 further including a step of providing a plurality of distinct templates each having a distinct unique designation code.

12. A method of creating a requested multimedia file from an initial file having at least one of an image and text utilizing a server having at least one template accessible therefrom with each template having a unique short code, said method comprising the steps of:
receiving the initial file at the server;
receiving the unique short code of a template at the server to define a selected template; and
characterized by automatically combining the initial file with the selected template to produce the requested multimedia file upon receiving the initial file and the unique short code at the server.

13. A method as set forth in claim 12 wherein said step of automatically combining the initial file with the selected template is further defined as automatically combining the image of the initial file with the selected template to produce the requested multimedia file.

14. A method as set forth in claim 12 wherein said step of automatically combining the initial file with the selected template is further defined as automatically combining text from the initial file with the selected template to produce the requested multimedia file.

15. A method as set forth in claim 12 wherein said step of receiving the short code is further defined as receiving the short code simultaneously with said step of receiving the initial file.

16. A method as set forth in claim 12 further including a step of receiving routing information simultaneously with the short code and the initial file.

17. A method as set forth in claim 16 further including a step of transmitting the requested multimedia file from the server based on the routing information.

18. A method as set forth in claim 12 wherein said method further utilizes a camera phone, said method further including a step of generating the initial file with the camera phone.

19. A method of creating a requested multimedia file from an initial file having at least one of an image and text utilizing a capture device and a server having at least one template accessible therefrom, said method comprising the steps of:
capturing the image of the initial file with the capture device;
receiving the initial file at the server;
providing a plurality of distinct templates each having a unique designation code;
receiving the unique designation code of the template at the server to define a selected template;
automatically combining the image of the initial file with the selected template to produce the requested multimedia file to produce the requested multimedia file upon receiving the initial file and the unique designation code at the server; and
wirelessly transmitting the requested multimedia file from the server to the capture device.
